(19) United States
(12) Patent Application Publication
(10) Pub. No.: US 2009/0020160 A1
(43) Pub. Date: Jan. 22, 2009

(54) SYSTEM AND METHOD FOR DISTRIBUTING CHEMICAL LIQUIDS

(76) Inventors: Herve DULPHY, Jarrie (FR); Jacqueline Tantet, Monestier De Clermont (FR); Frederique Taglione, St. Jean De Moirans (FR)

Correspondence Address: AIR LIQUIDE;Intellectual Property, 2700 POST OAK BOULEVARD, SUITE 1800, HOUSTON, TX, 77056, US

(21) Appl. No.: 11/766,856

(22) Filed: Jun. 22, 2007

(30) Foreign Application Priority Data
Dec. 22, 2005 (FR) PCT/FR2005/051135

(51) Int. Cl. F16L 58/00; F16L 9/12; F17D 1/00; F17D 3/16

(52) U.S. Cl. 137/1; 137/2; 137/15.05; 138/177; 428/36.9; 137/561 R

(57) ABSTRACT

The invention relates to a system for distributing chemical products in a factory producing flat screen semi-conductors or light-emitting diodes comprising means for storing said liquid products and means for the distribution and use thereof, wherein the liquid products are distributable from the storage means to the usage means by means of the distribution means.

This application is a 371 of International PCT Application PCT/FR2005/051135, filed Dec. 22, 2005.

The present invention relates to a system for distributing chemical liquids, in particular in a factory for the manufacture of semiconductors, and to a process for the implementation of such a system.

### BACKGROUND

It relates more particularly to a system for distributing chemicals, in particular in a factory for the manufacture of semiconductors, comprising means for storing said liquid products, means for distributing said liquid products and means for using said liquid products, the liquids being distributed from the storage means towards the use means via distribution means.

In manufacturing units, such as those mentioned above, many gases (in the gaseous form), many gases (in the liquefied form) and many chemical liquids are distributed from storage tanks up to the point of use via piping, valves, flow meters, and the like, generally made of stainless steel of 316L or 304L type. All these gases and liquids are generally purified according to very strict standards; during this purification, all kinds of impurities, in particular metallic impurities, are removed. Despite particularly rigorous control of the purity of the products used, the presence of an abnormal concentration of chromium has been found at different points of use. The great number of products used and their mixtures (for example with one another and/or with deionized water) makes it difficult a priori to determine the source of this abnormal concentration, in particular to determine a single source of contamination or the existence of multiple sources of contamination.

After having constructed many hypotheses and carried out investigations in many directions, a solution to the problem thus posed has finally been found.

The system according to the invention is characterized in that it comprises distribution means, at least a portion of which is made of natural polymer chosen from the group consisting of polyethylene, polypropylene, polyvinylidene fluoride (PVDF), polytetrafluoroethylene (PTFE), which may or may not be substituted, and copolymers of tetrafluoroethylene C₂F₄ and of perfluoroalkyl vinyl ether [F(CF₂)ₘCF₂OCF═CF₂], known under the generic name of PFA (perfluoroalkoxy) or MFA, which comprise the carbon-fluorine chain typical of polytetrafluoroethylene comprising side chains of perfluoroalkyl type via an oxygen atom, for connecting the means for storing liquids of the alcohol and/or acid type to the means for using these products.

Preferably, the liquid distribution means in direct contact with the liquid are either made of polymer of perfluoroalkoxy type, when the liquid is an alcohol or an acid, or made of chrome steel, in particular of the 316L or 304L type.

According to one alternative form, the liquid distribution means of pipe type will be sheathed by a steel pipe placed around and outside the PFA pipe.

In order to obtain an even better answer to the problem posed, the system according to the invention is characterized in that all the storage and distribution means up to the point of use are made of PFA.

According to one alternative form, which can depend on the mechanical properties of these various polymers (extrusion, machinability, flexibility, and the like), it is possible to combine these various polymers, in particular by making the storage means of natural polypropylene and/or of natural polyethylene, the distribution means of PFA and/or of MFA, and the faucets, valves, and the like, of PTFE.

The term “natural polymer” is understood to mean a polymer manufactured without addition of colorants or other additives (filler). Of course, other polymers may be suitable according to the invention and come within the field of application of the latter.

In order to determine whether these polymers may be suitable, it is sufficient to bring the liquid to be distributed (acid, alcohol, and the like) into contact with the natural polymer, for example while storing said liquid in a container produced using this polymer, for a period of time of at least 3 hours. The metals in the liquid are analyzed before this storage and after this storage, in particular metals such as chromium, iron, nickel, molybdenum and/or cobalt. The material is regarded as satisfactory if the increase in concentration of at least one of these metals remains below 10% by volume, preferably 5% by volume.

It has also been found that the contact time with a component made of stainless steel might be of importance.

This is why, according to the invention, the mean flow rate of alcohol or of acid in the piping made of polymer of the perfluoroalkoxy type should remain sufficient to obtain a concentration of chromium in said chemical liquid which remains below the desired value.

In particular, this is particularly important if the distribution circuit comprises parts made of stainless steel with which the chemical liquid may remain in prolonged contact.

It has also appeared desirable to provide, according to the invention, a process for employing the system during the startup (or restart) of the plant.

According to the invention, the liquid product is first of all circulated in the piping, so as to clear away any possible metal residues, in particular chromium, nickel, iron, molybdenum or cobalt, present at the surface of the piping (generally originating from its manufacturing process), this liquid product being discarded, during the first startup of the distribution means made of PFA or during the changing of a portion at least of these means, before circulating the uncontaminated liquid product up to the point of use of the latter.

A better understanding of the invention will be obtained using the following exemplary embodiments, given in conjunction with the figures, which represent:

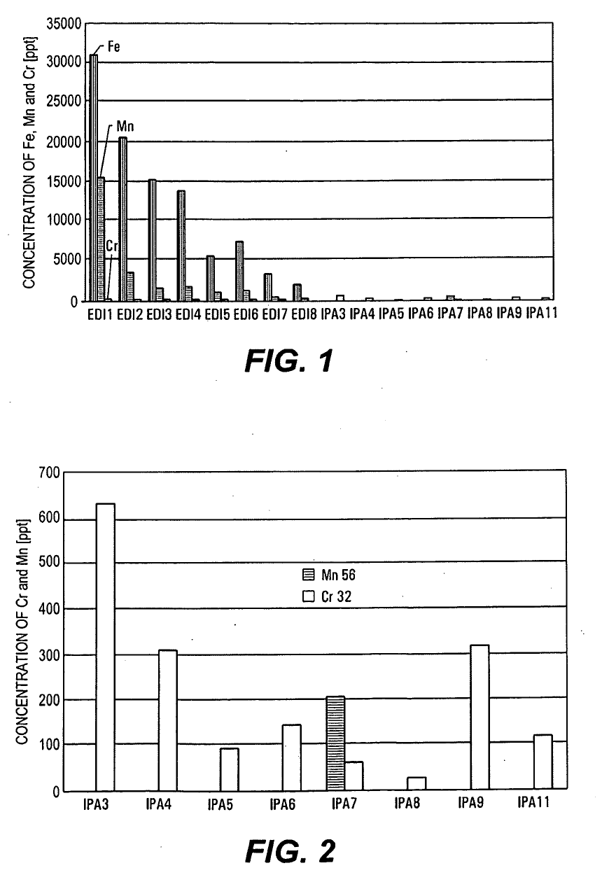

FIG. 1, the concentration (in ppt), of iron, manganese and chromium in the various samples of the analyzed water (EDI1, EDI2, and the like) and isopropyl alcohol (IPA3, IPA4, and the like) after contact with a pipe of 316L steel for 24 h;

FIG. 2, a representation, on a different scale, of the IPA samples of FIG. 1, only the chromium having a significant concentration;

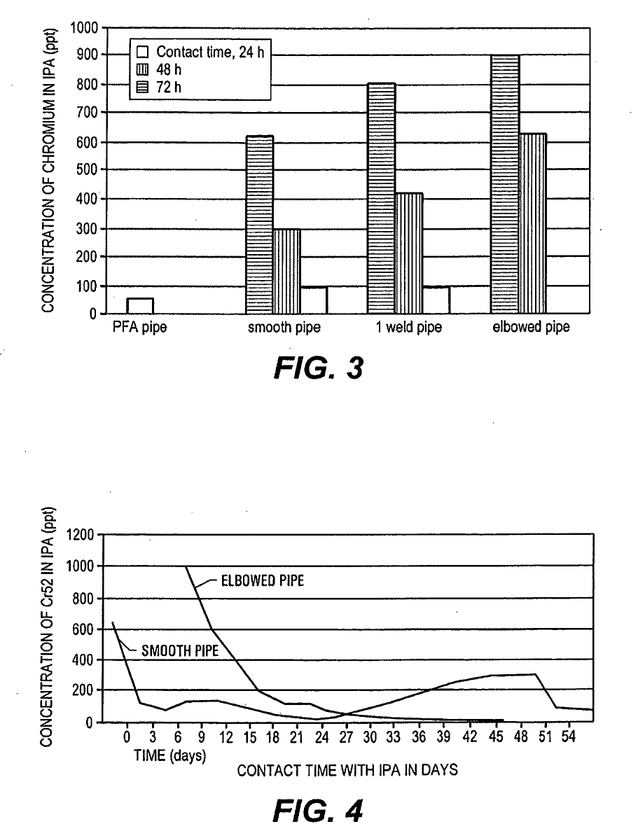

FIG. 3, a measurement of the concentration of chromium in a sample of isopropyl alcohol on contact with various pipes (PFA or chrome steel which is smooth, with a weld or elbowed) after 24 h, 48 h or 72 h; and

FIG. 4, a measurement of the concentration of chromium in isopropyl alcohol as a function of the time with a smooth pipe and an elbowed pipe made of 304L stainless steel.

### COMPARATIVE EXAMPLE

The following example was carried out on three series of different pipes:

The first series of pipes is composed of:
a pipe made of PFA
5 pipes made of 316L stainless steel: 1 straight and smooth pipe; 1 elbowed pipe; 1 pipe with a weld; 1 pipe with two welds; 1 pipe with two welds produced without a protective gas (orbital welding)

The second series of pipes is composed of 4 pipes made of 304L stainless steel: 1 straight pipe (21 cm); 1 elbowed pipe; 1 straight pipe with two welds.

The third series of pipes is composed of 4 pipes made of 316L stainless steel: 1 straight pipe; 1 straight pipe with a weld; 1 straight pipe with two welds; 1 straight pipe with two welds without a protective gas.

The pipes have a nominal diameter of 2.54 cm (internal diameter: 22.1 mm); working length: 300 mm.

The welds and the curves of the pipes were produced by ALES.

The metal pipes are equipped, in their bottom part, with plugs made of stainless steel (double-ring assembly). The pipes are closed by nonhermetic plastic plugs in the top part (this plug is not in contact with the liquid present in the pipe).

The PFA pipe has a PFA seal in the bottom part. The top part is closed in an identical fashion to the steel pipes.

In order to remove pollutants from the preparation, the pipes are cleaned in the following way:
rinsing under a stream of deionized water (EDI) for 24 h
rinsing with isopropyl alcohol (static mode) for 24 h
again rinsing with deionized water

The pipes are stored throughout the duration of the example under a laminar flow hood (class 100) at a temperature of 21° C. (±2° C.).

During the withdrawal, the contents of the pipe are decanted into a flask in order to homogenize the liquid: the amount necessary for the analyses is withdrawn from this flask and the remainder is discarded.

At each withdrawal, the pipe is rinsed once with deionized water or isopropyl alcohol and then again charged with the corresponding liquid.

The analyses of metals were carried out on a mass spectrometer of ICP-MS (inductively coupled plasma-mass spectroscopy) type in which the entities are ionized in an argon plasma, followed by detection as a function of the mass of the elements. The detection limits are on average 10 ppt in deionized water and 50 ppt in isopropyl alcohol. The accuracy of the results is 10% in the case of deionized water and 30% in the case of isopropyl alcohol. The results below are the mean of three samples taken in each withdrawal.

Results Obtained With Regard to Series 1:

The first series of pipes is the basis of the study: numerous measurement points were performed. The second series comprises two points in deionized water and three points in isopropyl alcohol with regard to the 304L steel. The third series comprises two points in deionized water and three points in isopropyl alcohol with regard to the 316L steel which confirms the results of the first series.

The results are expressed as concentration (ppt=nanogram/kilo or ng/liter in the case of deionized water) of each element reported per 24 hours of liquid/pipe contact. The volume of the pipes is of the order of 125 ml (±5 ml), except the straight pipe of the second series (# 83 ml±5 ml).

The first results in deionized water are represented in FIG. 1 (316L steel pipe). They correspond to the first day of pipe/liquid contact after the cleaning phase. The most important contaminants are iron, manganese and nickel. It is found that the concentration levels vary according to the nature of the pipe (weld, curve, and the like), that this concentration falls as a function of the time and that chromium does not appear to a significant extent in the deionized water. In FIG. 1, EDI means deionized water, EDI1 the sample of deionized water after 24 h, EDI2 the sample withdrawn after discarding EDI1, washing, and the like, filling with clean deionized water and contact for 24 h (from 24 h to 48 h), and the like.

The same notation of the samples of isopropyl alcohol IPA (IPA3, IPA4, and the like) is used with the same meaning.

In FIG. 2, the replacement of deionized water by isopropyl alcohol reveals a strong rise in contamination by chromium. The concentration of chromium stabilizes at approximately 100 ppt over time. Only chromium exhibits a noteworthy concentration.

The histogram of FIG. 3 (which represents the concentration of chromium in isopropyl alcohol after 24 h, 48 h and 72 h) shows that the concentration of chromium deposited in isopropyl alcohol using a PFA pipe is negligible and that there is, in the end, little difference between the pipes made of stainless steel, whether smooth, with welds or elbowed, the latter being that for which the concentration of chromium is the highest.

The diagram of FIG. 4 shows the change over time in the concentration of chromium in isopropyl alcohol after contact of the liquid with a pipe made of 304L stainless steel. The rise in chromium with regard to the smooth pipe after exposure for 25 days remains unexplained. It is found that the treatment undergone by the samples of stainless pipe has only a small effect on the contamination.

Results Obtained With Regard to Series 2 and 3:

They confirm the results obtained with regard to series 1. It is observed therein that the exposure of the samples to deionized water results in significant contamination by iron, manganese and chromium in decreasing order. The orders of magnitude are as follows:

In deionized water:
Fe: 5000 to 55 000 ppt
Mn: 1000 to 35 000 ppt
Cr: 100 to 1000 ppt

In conclusion, these comparative tests show that:
all the pipes made of stainless steel (304 or 316L), whatever their treatment, bring about a significant increase in the concentration of chromium in isopropyl alcohol on contact with the pipe,
pipes made of PFA (polyfluoroalkoxy) bring about only a very slight increase in the concentration of chromium in isopropyl alcohol on contact with the pipe. This increase in the concentration of chromium can be explained by the wear of the extrusion dies used for the production of these pipes.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-5. (canceled)

6. A system for distributing chemicals in a factory for the manufacture of semiconductors for flat screens or electroluminescent diodes comprising means for storing said liquid products, means for distributing said liquid products and means for using said liquid products, the liquids being distributed from the storage means towards the use means via distribution means, wherein it comprises distribution means, at least a portion of which is made of natural polymer chosen from the group consisting of polyethylene, polypropylene, polyvinylidene fluoride (PVDF), polytetrafluoroethylene (PTFE), which may or may not be substituted, and copolymers of tetrafluoroethylene C₂F₄ and of perfluoroalkyl vinyl ether [F(CF₂)ₘCF₂OCF═CF₂], known under the generic name of PFA (perfluoroalkoxy) or MFA, which comprise the carbon-fluorine chain typical of polytetrafluoroethylene comprising side chains of perfluoroalkyl type via an oxygen atom, for connecting the means for storing liquids of the alcohol and/or acid type to the means for using these products.

7. The system of claim 6, wherein the liquid distribution means in direct contact with the liquid are made of polymer of perfluoroalkoxy type, when the liquid is an alcohol or an acid, or made of chrome steel, in particular of the 316L or 304L type.

8. The system of claim 6, wherein all the storage and distribution means up to the point of use are made of PFA.

9. The process of claim 6, wherein the mean flow rate of alcohol or of acid in the piping made of polymer of the perfluoroalkoxy type should remain sufficient to obtain a concentration of chromium in said chemical liquid which remains below the desired value.

10. A process for implementing the system of one of the preceding claims, wherein the liquid product is first of all circulated in the piping, so as to clear away any possible metal residues, in particular chromium, nickel, iron, molybdenum or cobalt, present at the surface of the piping during its manufacture, this liquid product being discarded, before circulating the uncontaminated liquid product up to the point of use of the latter.
